(19) United States
(12) Patent Application Publication
(10) Pub. No.: US 2009/0134147 A1
(43) Pub. Date: May 28, 2009

(54) Method and apparatus for sealing high pressure vessels using magnetic pulsing with high radial impact speed; vessels manufacturing according to such methods

(75) Inventors: Oren GAFRI, Rishon Le-zion (IL); Yuri LIVSHITZ, Rishon Le Zion (IL)

Correspondence Address: HOUSTON ELISEEVA, 4 MILITIA DRIVE, SUITE 4, LEXINGTON, MA, 02421, US

(73) Assignee: PULSAR WELDING LTD., Yavne (IL)

(21) Appl. No.: 12/272,023

(22) Filed: Nov. 17, 2008

Related U.S. Application Data
(63) Continuation of application No. PCT/IL2007/000595, filed on May 16, 2007.
(60) Provisional application No. 60/801,238, filed on May 16, 2006.

(51) Int. Cl. B23K 13/01

(52) U.S. Cl. 219/617

(57) ABSTRACT

A pulsed magnetic method of sealing a vessel is provided. The method includes providing a vessel's body having at least one open end, providing a cover having a welding part. The welding part of the cover is placed over the open end of the vessel's body to overlap at least a portion of the vessel's body, thereby to define an air gap between the portion of the vessel's body and the welding part of the cover. A welding induction coil is provided around the vessel's body at least at the place where the welding part of the cover is located. The welding induction coil is energized to generate a pulsed magnetic force sufficient to cause bending the welding part of the cover in the air gap in a radially inward direction around the portion of the vessel's body. The pulsed magnetic force has such a value so as to provide an effective radial velocity value of the cover's welding part in the range of 150 m/sec to 600 m/sec at the moment of impact with the vessel's body, thereby to provide mutual diffusion of atoms of the vessel's body and the cover at their impact.

### RELATED APPLICATIONS

This application is a Continuation of PCT application serial number PCT/IL2007/000595, filed May 16, 2007, which claims the benefit under 35 USC 119(e) of U.S. Provisional Application No. 60/801,238, filed May 16, 2006, both of which are incorporated herein by reference in their entirety.

### FIELD OF THE INVENTION

This invention relates to a method and apparatus for sealing vessels by a pulsed magnetic force (PMF) and in particular, for sealing high pressure vessels.

### BACKGROUND OF THE INVENTION

A vessel such as a container, canister, tank, flask, etc. used, for example, for gas and/or liquid storage is usually produced by manufacturing a vessel body portion and a cover portion separately. For sealing the vessel, welding, brazing, soldering or crimping methods can be used for coupling the cover portion to the vessel body portion.

Welding hereinafter refers to a process in which two opposite surfaces of first and second workpieces form a “true” metallurgical bond (intermolecular bond), i.e., such a physical joint when the first and second workpieces become integrated with one another owing to mutual diffusion of their atoms.

Brazing is a joining process whereby a non-ferrous filler metal or alloy is heated to melting temperature (usually above 450° C.) and distributed between two or more close-fitting workpieces by capillary action. At its liquid temperature, the molten filler metal and flux interact with a thin layer of the base metal, cooling to form a sealed joint due to grain structure interaction. The brazed joint becomes a sandwich of different layers, each metallurgically bound to the adjacent layers.

Soldering refers to a process of joining metal parts using a filler material (solder) which has a melting temperature usually below 450° C. Soldering is distinguished from brazing by virtue of a lower melting-temperature filler metal; it is distinguished from welding by virtue of the base metal not melting during the joining process. In a soldering process, heat is applied to the parts to be joined, causing the solder to melt and be drawn into the joint by capillary action and to bond to the materials to be joined by wetting action.

In turn, crimping refers to such joining of two workpieces by deforming (or swaging) one or both of them to hold the other. As a result of crimping, a surface of at least one of the workpieces becomes wavy, bent, or pinched so as to provide a “pure” mechanical joint between the two workpieces without interpenetration of the atoms of the first workpiece into the body of the second workpiece.

Crimping is usually done by stamping or rolling. Moreover, various crimping techniques are also known in the art for sealing vessels, which utilize the force generated by a transient magnetic field.

For example, U.S. Pat. No. 3,581,456 to Gere describes a method for forming a closure on the neck finish of a filled container which utilizes the force generated by a transient magnetic field. The skirt of a cap, positioned on the neck of the container, is urged by the field against the neck finish so as to cause the skirt to conform to the contours of the neck finish and to thereby hold the cap in engagement with the neck finish upon the neck of the container.

U.S. Pat. No. 4,934,552 to Koide et al. describes a method for producing a sealed vessel including a cylindrical body portion having an open end, and a cover fitting in the open end of the body portion. The sealed vessel is produced by pressing the open end of the body portion from the outside of the body portion to an outer peripheral surface of the cover provided with at least one of annular grooves around the outer peripheral surface of the cover. In the case of using an electromagnetic force as the means for press-working, a part of the body portion is strictly and air-tightly fixed to the annular grooves in a moment and thus the sealed vessel is produced.

U.S. Pat. No. 5,191,775 to Shiina et al. describes a technique for sealing a refrigerating-medium storage vessel which comprises a tubular body having a bottom and an open upper end portion, and a closure fitted in the open end portion. The open end portion is constricted and crimped by electromagnetic forming and is thereby secured to the closure by bending and matching groove. U.S. Pat. No. 5,191,775 states that the method does not employ welding for joining the closure to the body.

U.S. Pat. No. 5,671,522 to Aronne describes another swaging technique for sealing a container by magnetic pulse forming techniques. The container is closed by means of a pair of specially constructed end caps each having annular recesses formed around their circumference. The ends of the container are engaged within the recess and joined by magnetic pulse forming. The magnetic pulse force is asserted radially inward against a mandrel which mates with a depression formed in the caps.

It should be understood that the sealing of a gas storage vessel by crimping can be used for pressure vessels designed for pressure that does not exceed several bars, for example, for sealing pressure vessels used in refrigerators and air conditioning systems which are filled with chlorofluorocarbon (CFC) refrigerants, e.g., Freon. However, it is recognized that CFCs are global-warming and ozone-depleting chemicals that provide a harmful effect on the Earth's atmosphere. Specifically, the ozone hole over the Antarctic was discovered, and heightened world attention led to the Montreal Protocol of 1989. Over the same period, it was discovered that CFCs also contributed significantly to the world's greenhouse warming problem. Thus, replacement of global-warming and ozone-depleting chemicals with environmentally friendly materials is now a major issue.

One of the solutions for mitigating the harmful effect of CFCs on the global atmosphere is to use environmentally friendly carbon dioxide as a refrigerant instead of conventional global-warming and ozone-depleting chemicals. Although carbon dioxide is a global-warming gas, conventional refrigerants (e.g., chlorofluorocarbons and hydrofluorocarbons) cause about 1000 times more global warming than the same quantity of carbon dioxide. Meanwhile, the tiny quantities of carbon dioxide that would be released from air conditioners would be insignificant, compared to the huge amounts produced from burning fossil fuels for energy and transportation.

One drawback to carbon dioxide air-conditioning systems is that they must be operated at high pressures, e.g., three times or higher as commonly seen in CFC technology. The need to operate at high pressure poses certain engineering challenges and requires the use of thick and heavy tubing. For example, when compared to a vessel filled with Freon, the wall thickness of a carbon dioxide filled vessel should be increased by 1.5 to 4.5 times.

The sealing methods based on crimping fail when the pressure in the vessel should be increased to the values required for carbon dioxide storage vessels. To overcome these difficulties, sealing of the vessel should be done by welding rather than crimping.

FIG. 1 illustrates an example when a cylindrical vessel's body 2 is sealed by a cover 1 by using a fusion welding technique at high temperature. One of the drawbacks of the fusion welding technique is in the fact that a heat affected zone 3 is formed due to the high temperature. The mechanical and metallurgical properties of the material at the heat affected zone 3 may differ significantly from the properties of the original material that deteriorates the quality and performance of the sealed vessel. In particular, it may require the use of thick vessel walls for storage of carbon dioxide at high pressure.

It is known in the art (see, for example, U.S. Pat. No. 5,824,998 to the Assignee of this application) that pulsed magnetic forming techniques can be used not only for crimping as described above in U.S. Pat. Nos. 3,581,456; 4,934,552; 5,191,775 and 5,671,522, but also for cold welding two metal workpieces without forming annealed transition zones.

A magnetic pulse technique for sealing a vessel by welding is described in WO 05002777 assigned to the Assignee of the present Application. The method includes providing a vessel's body having an open end, and a cover that includes a welding part and a brim part. A diameter of the cover at the welding part is less than the diameter of the vessel's body for providing an air gap between the vessel's body and the welding part. The cover is placed within said open end of the vessel's body. A welding induction coil is provided around the vessel's body at the place where the welding part of the cover is located. The welding induction coil is energized to generate a pulsed magnetic force sufficient to cause bending a portion of the vessel's body in a radially inward direction around the cover in the air gap. The pulsed magnetic force has such a value so as to provide mutual diffusion of atoms of the vessel's body and the cover at their impact, thereby to weld the vessel's body and the cover to each other.

Although the method described in WO 05002777 can be used for sealing high pressure vessels, application of this method is limited to specific vessel configurations, when the cover is placed inside the vessel's body.

### SUMMARY OF THE INVENTION

Despite the prior art in the area of sealing containers by magnetic pulse forming techniques, there is still a need in the art for, and it would be useful to have, a novel method for sealing high pressure vessels by utilizing magnetic pulse force (PMF) providing mutual diffusion of atoms between a vessel body and a cover.

Thus, according to one broad aspect of the invention there is provided a method of sealing a vessel, comprising:

(a) providing a vessel's body having at least one open end;

(b) providing a cover having a welding part;

(c) placing the welding part of the cover over said at least one open end of the vessel's body to overlap at least a portion of the vessel's body, thereby defining an air gap between said portion of the vessel's body and the welding part of the cover;

(d) providing a welding induction coil around said vessel's body at least at the place where the welding part of the cover is located; and

(e) energizing said welding induction coil by applying a working voltage U thereacross having a predetermined value required to generate a pulsed magnetic force sufficient to cause bending the welding part of the cover in said air gap in a radially inward direction around said portion of the vessel's body, said predetermined value of the working voltage has such a value so as to provide an effective radial velocity value of the cover's welding part in the range of 150 m/sec to 600 m/sec at the moment of impact with the vessel's body, thereby to provide mutual diffusion of atoms of the vessel's body and the cover at their impact.

According to an embodiment of the present invention, the welding part can be located near the open end of the vessel's body.

According to an embodiment of the present invention, the cover has a holding part arranged inside the vessel's body.

Preferably, the apparent tangential velocity of a front contact line in the joint area is in the range of 1000 m/sec-2500 msec.

According to an embodiment of the present invention, the working voltage U can be obtained by

$$U = {kV}_{r} \sqrt{\frac{{r}_{w} {l}_{w} {h}_{c} {δ}_{w} {ρ}_{w}}{{h}_{g} C}} ,$$

where ρ_{w}, r_{w}, δ_{w} and I_{w} are the material density (in kg/m3), inner radius, thickness and length (in m) of the welding part, correspondingly, h_{g} is the thickness (in m) of the annular air gap, h_{c} is the thickness (in m) of the clearance between the induction coil and the welding part, L_{coil} is a longitudinal dimension of the coil 22 in the working zone (e.g., L_{coil}≧l_{w}), C is the capacitance (in F) of an energy storage bank of a pulsed welding apparatus (not shown), Vᵣ is the velocity (in m/sec) of the of the cover's welding part in the radial direction at the impact, and k is an empirical coefficient that can vary its value in the range of 3 to 15.

Accordingly, the energy W required for welding the vessel's body to the welding part of the cover can be obtained by

W=2/πVᵣ²r_{w}h_{c}l_{w}δ_{w}ρ_{w}/h_{g}

According to an embodiment of the present invention, a resilient o-ring is placed in the gap between the cover and the vessel's body prior to the energizing of the welding induction coil.

According to another broad aspect of the invention there is provided a method of sealing a vessel, comprising:

(a) providing a vessel's body having at least one open end;

(b) providing a cover having a recess adapted for placing an end portion of the vessel's body therein;

(c) placing said at least one open end into the recess;

(d) providing a sealing cylinder over the cover and said end portion of the vessel's body placed in the recess such that the cylinder overlaps the cover and the end portion of the vessel's body, thereby defining an air gap therebetween;

(e) providing a welding induction coil around said sealing cylinder at least at the place where the cover and the end portion of the vessel's body are located; and

(f) energizing said welding induction coil by applying a working voltage U thereacross having a predetermined value required to generate a pulsed magnetic force sufficient to cause bending of the sealing cylinder in said air gap in a radially inward direction, said predetermined value of the working voltage has such a value so as to provide an effective radial velocity value of a bending portion of the cylinder in the range of 150 m/sec to 600 m/sec at the moment of impact with said cover and said end portion of the vessel's body, thereby to provide mutual diffusion of atoms of bending portion of the sealing cylinder with atoms of the cover and the vessel's body at their impact.

According to a further embodiment of the present invention, the method further comprises:

providing at least one additional sealing cylinder;

applying said at least one additional sealing cylinder over said sealing cylinder; and

joining the additional sealing cylinder with said sealing cylinder.

The working voltage U can be obtained by

$$U = {kV}_{r} \sqrt{\frac{{r}_{cyl} {l}_{cyl} {h}_{c} {δ}_{cyl} {ρ}_{cyl}}{{h}_{g} C}} ,$$

where ρ_{cyl}, r_{cyl}, δ_{cyl} and l_{cyl} are the material density (in kg/m³), inner radius, thickness and length (in m) of the sealing cylinder, correspondingly, h_{g} is the thickness (in m) of the annular air gap, h_{c} is the thickness (in m) of a clearance between the induction coil and the sealing cylinder, C is the capacitance (in F) of an energy storage bank of a pulsed welding apparatus, Vᵣ is the velocity (in m/sec) of the of the sealing cylinder in the radial direction at the impact, and k is an empirical coefficient.

Accordingly, the energy W required for welding the vessel's body (21) to the sealing cylinder can be obtained by

W=k²Vᵣ²r_{cyl}h_{c}l_{cyl}ρ_{cyl}δ_{cyl}/h_{g}

According to still another broad aspect of the present invention, there is provided a sealed vessel fabricated by a method according to any one of the embodiments described above.

The sealed vessel and sealing method of the present invention have many of the advantages of the aforementioned techniques, while simultaneously overcoming some of the disadvantages normally associated therewith.

The sealed vessel according to the present invention is of durable and reliable construction.

The sealed vessel according to the present invention may have a low manufacturing cost.

In particular, when compared to the vessels and sealing method based on fusion welding, the vessels can have much less wall thickness, due to the absence of the heat affected zone. For example, when the vessel is made of Aluminum 6061 T6, the heating during the diffusion welding process transforms the heat affected zone of the vessel into Aluminum 6061-W (welded) form with a decrease of yield strength from 276 MPa to 80 MPa. As a result, in order that a vessel may withstand the pressure of at least 40 MPa, its thickness should be increased from 3.5 mm (for Aluminum 6061 T6) to 12 mm (for Aluminum 6061-W).

In turn, when compared to the vessels formed by crimping techniques, the sealed vessel according to the present invention may better hold high pressure or vacuum. For example, at the helium leak test, the welded parts made by magnetic pulse welding can hold the vacuum up to the values of 10⁻¹⁰ mm Hg, whereas the joint parts by crimping methods can not hold any vacuum at the leak test.

Examples of applications of the sealing technique of the present invention include, but are not limited to, producing such parts of air conditioning systems as air accumulators, air dryers, air receivers, etc.

For example, a sealed vessel fabricated by the method of the present invention can be used for storing compressed carbon dioxide.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a cross-sectional view of a vessel after a sealing by a diffused welding process;

FIG. 2 illustrates a cross-sectional view of a vessel before a sealing process, according to one embodiment of the invention;

FIG. 3 illustrates a cross-sectional view of a vessel before a sealing process, according to another embodiment of the invention;

FIGS. 4A through 4D illustrate a sequence of stages of the welding process, according to an embodiment of the invention;

FIGS. 5A and 5B illustrate a cross-sectional view of a part of the vessel after a sealing process, according to yet another embodiment of the invention;

FIGS. 6A and 6B illustrate two stages of the welding process of a vessel, according to still another embodiment of the invention;

FIG. 6C illustrates a cross-sectional view of a part of the vessel's portion after a sealing process, according to a further embodiment of the invention; and

FIG. 7 illustrates a cross-sectional view of a part of the vessel's portion after a sealing process, according to yet another embodiment of the invention.

### DETAILED DESCRIPTION OF THE PREFERRED EMBODIMENTS

The principles and operation of a method and an apparatus according to the present invention may be better understood with reference to the drawings and the accompanying description, it being understood that these drawings are given for illustrative purposes only and are not meant to be limiting. The same reference numerals will be utilized for identifying those components which are common in the vessel and the working coil shown in the drawings throughout the present description of the invention. Dimensions of vessel, thickness of the walls of the vessel and cover as well as gaps between the vessel and cover and their portions may be exaggerated for clarity.

Referring to FIG. 2, a cross-sectional view of a vessel 20 before a welding process is illustrated, according to one embodiment of the invention. The vessel 20 includes a cylindrical vessel's body 21 having an open end and a cover 23. The cover 23 has a welding part 24 that overlaps a portion of the cylindrical vessel's body 21. The cover 23 has also a holding part 25 adapted to hold the cover 23 inside the vessel's body 21. Therefore, a diameter dₕ of the cover 23 at the holding part 25 is equal to the inner diameter dᵢₙ of the vessel's body 21. According to the present invention, an inner diameter d_{w} of the cover 23 at the welding part 24 is higher than the outer diameter dₒᵤₜ of the vessel's body 21, so as to provide an annular air gap 26 between the cylindrical vessel's body 21 and the cover's welding part 24, when the cover 23 is placed into the open end of the vessel's body 21. Preferably, the overlap between the welding part 24 and the cylindrical vessel's body 21 is more than two times greater than the thickness of the welding part 24.

The vessel 20 may be constructed of any suitable metal material having the required strength and forming characteristics for the particular application. It should be appreciated that the vessel's body 21 and the cover 23 can be made of the same material or different materials. Examples of the metal materials from which the vessel's body 21 and the cover 23 are made include, but are not limited to, aluminum, low carbon steel, brass, copper. It should be appreciated that alloys of these and other materials can also be used.

In order to provide a force required for welding the cover 23 to the vessel's body 21, a high power pulsed magnetic field is generated around the vessel's body 21 at the place where the cover's welding part 24 is located over the vessel's body 21. A device suitable for providing a required pulsed magnetic field is known per se, and therefore its construction and operation will not be expounded hereinbelow. For example, the device described in U.S. Pat. No. 5,824,998 to the Assignee of this application, incorporated herein by reference, can be used for the purpose of the present invention. Such a device includes a welding induction coil 22, which can be configured in accordance with a specific application. In FIG. 2 the welding induction coil 22 surrounds the vessel's body 21 at the place where the welding part 24 of the cover is located. When desired, a longitudinal dimension L_{coil} of the coil 22 is greater than the longitudinal dimension l_{w} of the welding part 24 and configured such that the pulsed magnetic force produced by the induction coil 22 for bending the cover's welding part 24 would be concentrated at an edge 28 of the welding part 24. It should be noted that the joint area has a clearance 44 for the coil 22 surrounding the welding part 24.

Referring to FIG. 3, a cross-sectional view of a vessel 30 before a welding process is illustrated, according to another embodiment of the invention. According to this embodiment, the cylindrical vessel 30 is open at two ends. Thus, covers 27a and 27b can be used to seal the vessel's body 31 at the two open ends, when desired.

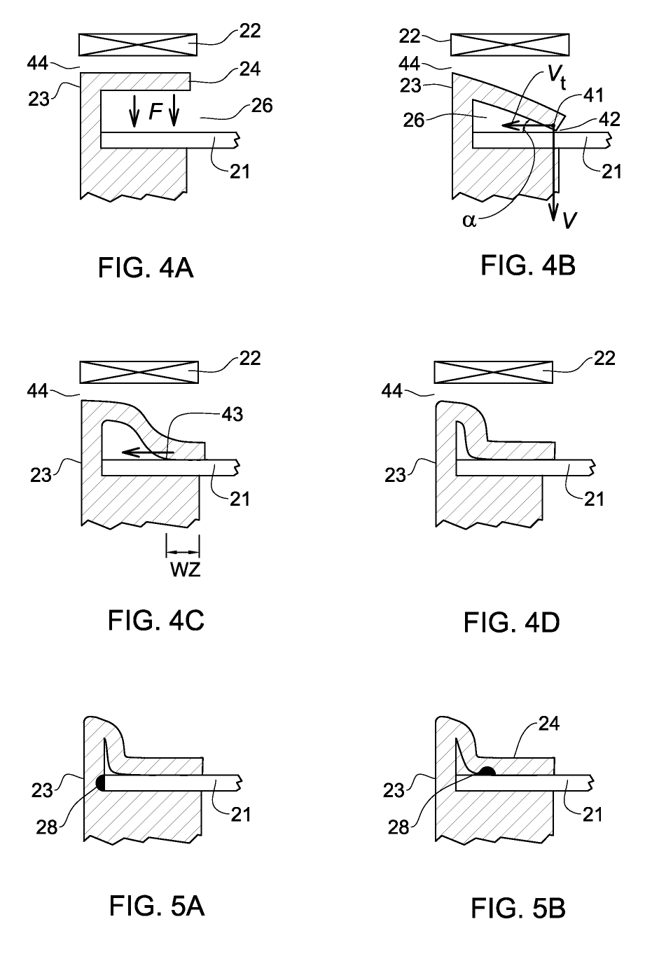

Referring to FIGS. 4A-4D, a sequence of stages of the welding process is illustrated, according to an embodiment of the invention. It should be noted that these figures are not to scale, and are not in proportion, for purposes of clarity. In operation, a pulsed magnetic force F, associated with the magnetic field generated by the welding induction coil 22, is applied to the welding part 24 of the cover 23 (see FIG. 4A). According to this embodiment, the welding part 24 is located near the open end of the vessel's body 21. However, it should be understood that the location of the vessel's welding part 24 is not limited to any part of the vessel's body 21 along its length.

It should be noted that contrary to the prior art crimping techniques (where the joint portions are attached to each other before applying a pulsed magnetic field), the pulsed magnetic welding method of the present invention teaches to use the gap 26 between the cover's welding part 24 and the vessel's body 21. Such a gap provides for the cover's welding part 24 a possibility to move under acceleration towards the vessel's body 21 to achieve a high velocity value sufficient for mutual diffusion of atoms of the vessel's body and the cover at their impact.

The process of welding the vessel for sealing thereof includes energizing the welding induction coil 22 to produce the pulsed magnetic force F for bending the cover's welding part 24 in a radially inward direction around the vessel's body 21. The welding starts at the moment when an edge 41 of the welding part 24 contacts a surface 42 of the vessel's body 21 (see FIG. 4B). During the welding, the front contact line 43, defining the welding zone WZ around the vessel's body 21, moves tangentially towards the vessel's end (see FIG. 4C), thereby sealing the vessel (see FIG. 4D).

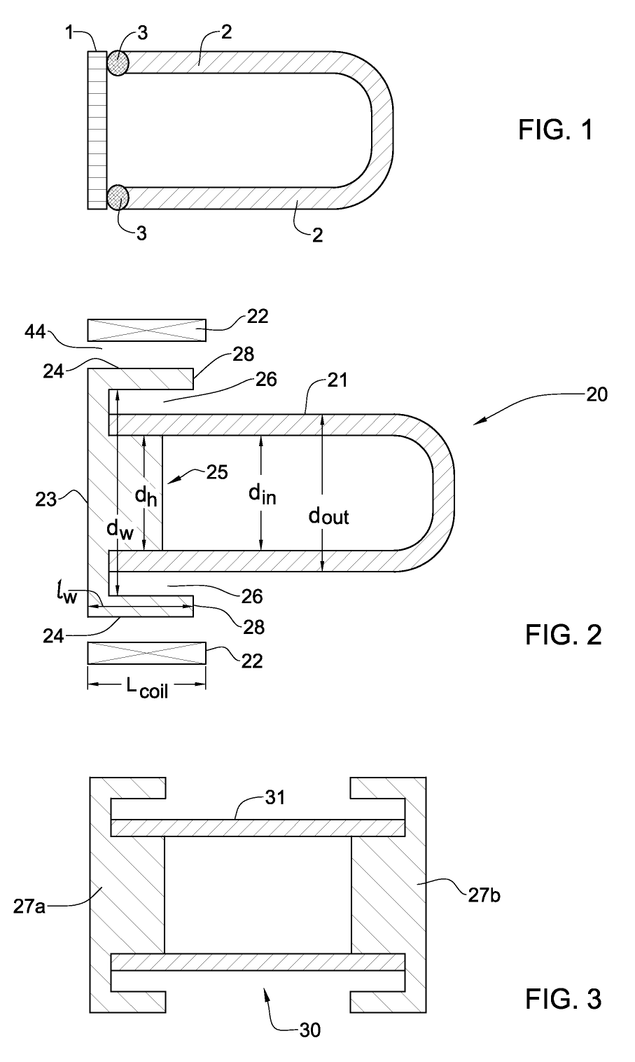

It should be understood that in order to provide mutual diffusion of the atoms required for the welding of the vessel's body to the cover at the high-velocity impact, the pulsed magnetic force F should have a predetermined value. More specifically, the pulsed magnetic force F must have such a value so that the cover's welding part 24, during its accelerated motion in the gap 26 towards the surface 42 of the vessel's body 21, could attain a velocity sufficient for penetration of the atoms of the vessel's body into the space between the atoms of the cover. Specifically, the applicants found that for the configuration of the cover's welding part 24 and the vessel's body 21 shown in FIGS. 1 and 2, the welding can be established when an effective value of the velocity Vᵣ of the cover's welding part 24 in the radial direction at the impact is in the range of about 150 m/sec-600 m/sec, whereas the apparent tangential velocity Vₜ of the front contact line 43 in the joint area is in the range of about 1000 m/sec-2500 m/sec. The apparent tangential velocity Vₜ can be obtained by Vₜ=Vᵣ/tan α, where α is the impact angle.

Under such controlled impact, a high-pressure collision is created between the two surfaces of the metals to be bonded. The atoms of the two adjacent metals are propelled together with such force that they actually overcome their natural repulsion forces and result in a stable equilibrium as they share electrons. The process uses pressure, not heat, and thereby avoids all the conventional heat-induced problems found in welding, such as phase changes, the formation of intermetallics, recrystallized grains, etc. The bond can even be stronger than the host materials themselves, as limit failure occurs in the weaker of the two metals and not at the bonded interface. The absence of heat in the process makes it possible to bond metals with widely different melting temperatures, e.g., aluminum and steel.

Moreover, owing to the high tangential velocity Vₜ of the front contact line 43 a jet is created between the two bonded surfaces by the impact force acting upon them. This jetting action removes traces of oxides, surface contaminants and any dirt from the welding zone, allowing the magnetic pressure caused impact to plastically deform the metals for a short instant and to drive the mating surfaces together. This allows the two virgin surfaces, stripped of their oxide layers, to be welded together under very high pressure, bringing the atoms of each metal into close enough contact with each other, to allow the atomic forces of attraction to come into play.

The present invention defines physically justified direction for calculating in advance the voltage U applied across the induction coil 22, and/or the energy W required for welding the vessel's body 21 and the cover 23 to each other. Specifically, the predetermined voltage U and the energy W have to be such that (i) the welding part 24 of the cover 23 during its movement towards the vessel's body 21 attains at the impact a velocity value in the inward direction in the range of about 150 m/sec to 600 m/sec and (ii) a contact front line 43 attains at the impact a tangential velocity value in the range of about 1000 m/sec to 2500 m/sec”.

Specifically, by taking into account the velocity values provided by the present invention, a person skilled in the art can always calculate the magnitude of the voltage U applied across the induction coil and/or the energy W required in order to weld the vessel's body 21 to the welding part 24 of the cover 23, providing mutual diffusion of the atoms.

For example, the working voltage U required for welding the welding part 24 and vessel's body 21 can be estimated by

$$U = {kV}_{r} \sqrt{\frac{{r}_{w} {l}_{w} {h}_{c} {δ}_{w} {ρ}_{w}}{{h}_{g} C}} ,$$

where ρ_{w}, r_{w}, δ_{w} and l_{w} are the material density (in kg/m³), inner radius, thickness and length (in m) of the welding part 24, correspondingly, h_{g} is the thickness (in m) of the annular air gap 26, h_{c} is the thickness (in m) of the clearance 44 between the induction coil 22 and the welding part 24, L_{coil} is a longitudinal dimension of the coil 22 in the working zone (e.g., L_{coil}≧l_{w}), C is the capacitance (in F) of an energy storage bank of a pulsed welding apparatus (not shown), Vᵣ is the velocity (in m/sec) of the of the cover's welding part 24 in the radial direction at the impact, and k is an empirical coefficient that can vary its value in the range of 2 to 20.

Accordingly, the energy W required for welding the vessel's body 21 to the welding part 24 of the cover 23 can be obtained by

W=k²Vᵣ²r_{w}h_{c}l_{w}δ_{w}ρ_{w}/h_{g}

For example, when the welding parameters are set to ρ_{w}=2700 kg/m³ (Aluminum); r_{w},=0.02 m; h_{c}=0.0015 m; h_{g}=0.0015 m; l_{w}=0.015 m; δ_{w}=0.002 m; C=550 μF; Vᵣ=300 m/s and k=10 the working voltage U equals to about 5 kV, whereas the energy W required for welding equals to about 16 kJ.

Referring to FIG. 5A and FIG. 5B, cross-sectional views of joint areas after welding are illustrated, according to further embodiments of the invention. According to these embodiments, in order to enhance the sealing function, a resilient o-ring 28 is placed in the gap between the cover 23 and the vessel's body 21 prior to the energizing of the welding induction coil. According to the example shown in FIG. 5A, the o-ring 28 is placed at the butt end of the vessel's body 21. However, when desired, the o-ring 28 can be placed at any other place between the cover's welding part 24 and the vessel's body 21 (see FIG. 5B).

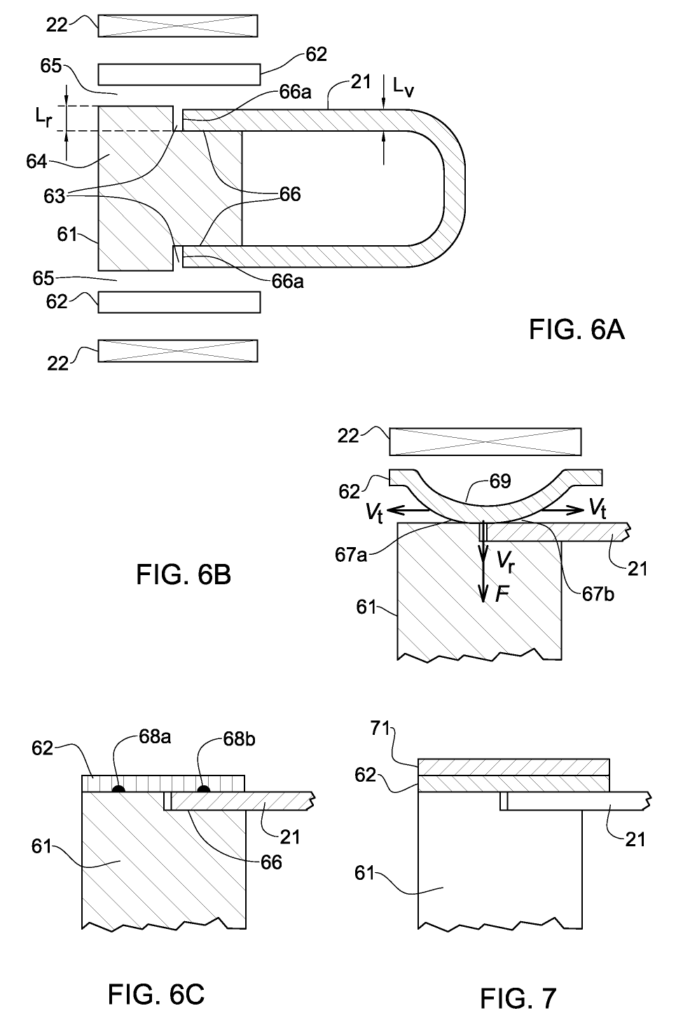

Referring to FIGS. 6A and 6B together, two stages of the welding process of a vessel are illustrated, according to still another embodiment of the invention. According to this embodiment, the vessel's body 21 is jointed to a cover 61 by using a sealing cylinder 62. In this case, the cover 61 has a recess 63 in which an end portion 66 of the vessel's body 21 is placed. Preferably, the depth lᵣ of the recess 63 is equal to the thickness lᵥ (lᵥ=dₒᵤₜ−dᵢₙ) of the vessel's body 21. In such a construction, a diameter of the cover 61 at its butt end 64 is equal to the outer diameter of the vessel's body 21.

As shown in FIG. 6A, the sealing cylinder 62 is placed over the cover 61 and the end portion 66 of the vessel's body 21 such that the cylinder 62 overlaps the cover 61 and the end portion 66 of the vessel's body 21. A dimension of the cylinder is such that a gap 65 is provided between the inner surface of the sealing cylinder 62 and the cover 61 abutted to the end portion 66 of the vessel's body 21 placed in the recess 63.

In order to weld the cover 61, the vessel's body 21 and the cylinder 62 together, the welding induction coil 22 is placed around the sealing cylinder 62, preferably, centered at the location of the butt end 66a of the end portion 66. Energizing of the coil 22 will cause bending of the cylinder 62 (see FIG. 6B) centered at this location.

According to this embodiment of the invention, the pulsed magnetic force F must have such a value so that a bending portion 69 of the sealing cylinder 62 during its movement in the gap 65 could attain a velocity in the radial direction sufficient for penetration of its atoms into the space between the atoms of the vessel's body 21 and the atoms of the cover 61, thereby welding the cover 61, the vessel's body 21 and the bending portion 69 of the cylinder 62 together. The high tangential velocity Vₜ of the front lines 67a and 67b results in two opposite jets created between the two bonded surfaces. This jetting action removes traces of oxides, surface contaminants and any dirt from the welding zone, allowing the magnetic pressure caused impact to plastically deform the metals for a short instant and to drive the mating surfaces together. For example, welding can be established when an effective value of the velocity of the bending portion 69 of the sealing cylinder 62 in the radial direction at the impact is in the range of about 150 m/sec-600 m/sec, whereas the apparent tangential velocity Vₜ of the front line in the joint area is in the range of about 1000 m/sec-2500 m/sec.

Values of the working voltage and energy required for welding, as well as the magnetic field B in the gap 65 (calculated in Tesla) generated by the induction coil 22 can be calculated as described above.

Specifically, the working voltage U can be obtained by

$$U = {kV}_{r} \sqrt{\frac{{r}_{cyl} {l}_{cyl} {h}_{c} {δ}_{cyl} {ρ}_{cyl}}{{h}_{g} C}} ,$$

where ρ_{cyl}, r_{cyl}, δ_{cyl} and l_{cyl} are the material density (in kg/m³), inner radius, thickness and length (in m) of the sealing cylinder (62), correspondingly, h_{g} is the thickness (in m) of the annular air gap (65), h_{c} is the thickness (in m) of a clearance between the induction coil (22) and the sealing cylinder (62), C is the capacitance (in F) of an energy storage bank of a pulsed welding apparatus, Vᵣ is the velocity (in m/sec) of the of the sealing cylinder (62) in the radial direction at the impact, and k is an empirical coefficient. Accordingly, the energy W required for welding the vessel's body (21) to the sealing cylinder (62) can be obtained by

W=k²Vᵣ²r_{cyl}h_{cyl}ρ_{cyl}δ_{cyl}/h_{g}

When desired, in order to enhance the sealing function, resilient o-rings 68a and 68b can be placed between the cover 61 and the sealing cylinder 62, and between the cover 61 and the end portion 66 of the vessel's body 21, correspondingly, prior to the sealing process (see FIG. 6C).

Referring to FIG. 7, a cross-sectional view of a vessel after a sealing process is illustrated, according to yet another embodiment of the invention. According to this embodiment, a sealing process of the vessel's body 21 is carried out in two stages. At the first stage, a join of the vessel's body 21, the cover 61 and the sealing cylinder 62 is achieved as described above with reference to FIGS. 6A and 6B. At the second stage, the sealing can be reinforced by applying an additional sealing cylinder 71 over the sealing cylinder 62. In such a case the sealing wall will be composed of two cylinders, such as the sealing cylinders 62 and 71.

According to one example, the additional sealing cylinder 71 is jointed with the sealing cylinder 62 by the welding process similar to the welding method described above for the cylinder 62.

According to another example, the additional sealing cylinder 71 can be jointed with the sealing cylinder 62 by any one of the prior art crimping methods described above in the background section.

It should be understood that when required, the sealing can be further enhanced by applying more than one additional cylinder (not shown), thereby increasing the total thickness of the sealing wall.

As such, those skilled in the art to which the present invention pertains, can appreciate that while the present invention has been described in terms of preferred embodiments, the concept upon which this disclosure is based may readily be utilized as a basis for the designing of other structures, systems and processes for carrying out the several purposes of the present invention.

It is apparent that although the examples of the vessel of the present invention were shown for the vessel body portion having a circular cross-section, the sealing method of the present invention can be applied, mutatis mutandis, for the sealing of a vessel having an arbitrary cross-sectional shape.

Also, it is to be understood that the phraseology and terminology employed herein are for the purpose of description and should not be regarded as limiting.

In the process claims that follow, alphabetic characters used to designate claim steps are provided for convenience only and do not imply any particular order of performing the steps.

It is important, therefore, that the scope of the invention is not construed as being limited by the illustrative embodiments set forth herein. Other variations are possible within the scope of the present invention as defined in the appended claims and their equivalents.

What is claimed is:

1. A pulsed magnetic method of sealing a vessel, comprising:
(a) providing a vessel's body (21) having at least one open end;
(b) providing a cover (23) having a welding part (24);
(c) placing the welding part (24) of the cover (23) over said at least one open end of the vessel's body (21) to overlap at least a portion of the vessel's body, thereby defining an air gap (26) between said portion of the vessel's body (21) and the welding part (24) of the cover (23);
(d) providing a welding induction coil (22) around said vessel's body at least at the place where the welding part (24) of the cover (23) is located; and
(e) energizing said welding induction coil (22) by applying a working voltage U thereacross having a predetermined value required to generate a pulsed magnetic force sufficient to cause bending the welding part (24) of the cover (23) in said air gap (26) in a radially inward direction around said portion of the vessel's body (21), said predetermined value of the working voltage has such a value so as to provide an effective radial velocity value of the cover's welding part (24) in the range of 150 m/sec to 600 m/sec at the moment of impact with the vessel's body (21), thereby to provide mutual diffusion of atoms of the vessel's body (24) and the cover (23) at their impact.

2. The method of claim 1, wherein the welding part (24) is located near the open end of the vessel's body (21).

3. The method of claim 1, wherein the apparent tangential velocity of a front contact line (43) in the joint area is in the range of 1000 m/sec-2500 m/sec.

4. The method of claim 1, wherein a working voltage U required for welding the welding part (24) and vessel's body (21) is obtained by
$$U = {kV}_{r} \sqrt{\frac{{r}_{w} {l}_{w} {h}_{c} {δ}_{w} {ρ}_{w}}{{h}_{g} C}} ,$$
where ρ_{w}, r_{w}, δ_{w} and l_{w} are the material density (in kg/m³), inner radius, thickness and length (in m) of the welding part (24), correspondingly, h_{g} is the thickness (in m) of the annular air gap (26), h_{c} is the thickness (in m) of the clearance (44) between the induction coil (22) and the welding part (24), C is the capacitance (in F) of an energy storage bank of a pulsed welding apparatus, Vᵣ is the velocity (in m/sec) of the of the cover's welding part (24) in the radial direction at the impact, and k is an empirical coefficient.

5. The method of claim 1, wherein an energy W required for welding the vessel's body (21) to the welding part (24) of the cover (23) is obtained by
W=2πVᵣ²r_{w}h_{c}l_{w}δ_{w}ρ_{w}/h_{g}
where ρ_{w}, r_{w}, δ_{w} and l_{w} are the material density (in kg/m³), inner radius, thickness and length (in m) of the welding part (24), correspondingly, correspondingly, h_{g} is the thickness (in m) of the annular air gap (26), h_{c} is the thickness (in m) of the clearance (44) between the induction coil (22) and the welding part (24), Vᵣ is the velocity (in m/sec) of the of the cover's welding part (24) in the radial direction at the impact, and k is an empirical coefficient.

6. The method of claim 4, wherein k is in the range of 2 to 20.

7. The method of claim 1, wherein the cover (23) has a holding part (25) arranged inside the vessel's body (21).

8. The method of claim 1, comprising placing a resilient o-ring (28) in the gap between the cover (23) and the vessel's body (21) prior to said energizing of the welding induction coil (22).

9. The method of claim 1, wherein said welding induction coil (22) is configured to generate a pulsed magnetic force at an edge of the welding part (24).

10. The method of claim 1, further comprising storing compressed carbon dioxide in said vessel after sealing.

11. A sealed vessel fabricated by a pulsed magnetic method according to claim 1.

12. A pulsed magnetic method of sealing a vessel, comprising:
(a) providing a vessel's body (21) having at least one open end;
(b) providing a cover (61) having a recess (63) adapted for placing an end portion (66) of the vessel's body (21) therein;
(c) placing said at least one open end (66) into the recess (63);
(d) providing a sealing cylinder (62) over the cover (61) and said end portion (66) of the vessel's body (21) placed in the recess (63) such that the cylinder (62) overlaps the cover (61) and the end portion (66) of the vessel's body (21), thereby defining an air gap (65) therebetween;
(e) providing a welding induction coil (22) around said sealing cylinder (62) at least at the place where the cover (61) and the end portion (66) of the vessel's body (21) are located; and
(f) energizing said welding induction coil (22) by applying a working voltage U thereacross having a predetermined value required to generate a pulsed magnetic force sufficient to cause bending of the sealing cylinder (62) in said air gap in a radially inward direction, said predetermined value of the working voltage has such a value so as to provide an effective radial velocity value of a bending portion (69) of the cylinder (62) in the range of 150 m/sec to 600 m/sec at the moment of impact with said cover (61) and said end portion (66) of the vessel's body (21), thereby to provide mutual diffusion of atoms of bending portion (69) of the sealing cylinder (62) with atoms of the cover (61) and the vessel's body (21) at their impact.

13. The method of claim 12, wherein the apparent tangential velocity of front contact lines in the joint area is in the range of 1000 m/sec-2500 m/sec.

14. The method of claim 12, wherein the working voltage U is obtained by
$$U = {kV}_{r} \sqrt{\frac{{r}_{cyl} {l}_{cyl} {h}_{c} {δ}_{cyl} {ρ}_{cyl}}{{h}_{g} C}} ,$$
where ρ_{cyl}, r_{cyl}, δ_{cyl} and l_{cyl} are the material density (in kg/m³), inner radius, thickness and length (in m) of the sealing cylinder (62), correspondingly, h_{g} is the thickness (in m) of the annular air gap (65), h_{c} is the thickness (in m) of a clearance between the induction coil (22) and the sealing cylinder (62), C is the capacitance (in F) of an energy storage bank of a pulsed welding apparatus, Vᵣ is the velocity (in m/sec) of the of the sealing cylinder (62) in the radial direction at the impact, and k is an empirical coefficient.

15. The method of claim 12, wherein an energy W required for welding the vessel's body (21) to the sealing cylinder (62) is obtained by
W=k²Vᵣ²r_{cyl}h_{c}l_{cyl}ρ_{cyl}δ_{cyl}/h_{g}
where ρ_{cyl}, r_{cyl}, δ_{cyl} and l_{cyl} are the material density (in kg/m³), inner radius, thickness and length (in m) of the sealing cylinder (62), correspondingly, h_{g} is the thickness (in m) of the annular air gap (65), h_{c} is the thickness (in m) of a clearance between the induction coil (22) and the sealing cylinder (62), Vᵣ is the velocity (in m/sec) of the of the sealing cylinder (62) in the radial direction at the impact, and k is an empirical coefficient.

16. The method of claim 14, wherein k is in the range of 2 to 20.

17. The method of claim 12, comprising placing two resilient o-rings (68a and 68b) in said air gap (65) prior to said energizing of said welding induction coil (22).

18. The method of claim 12, further comprising:
providing at least one additional sealing cylinder (71);
applying said at least one additional sealing cylinder (71) over said sealing cylinder (62);
joining the additional sealing cylinder (71) with said sealing cylinder (62).

19. The method according to claim 12, further comprising storing compressed carbon dioxide in said vessel after sealing.

20. A sealed vessel fabricated by a pulsed magnetic method according to claim 12.
